(19) United States
(12) Patent Application Publication
(10) Pub. No.: US 2006/0088079 A1
(43) Pub. Date: Apr. 27, 2006

(54) Ceramic bead insulators and articulating thermocouple assemblies

(76) Inventors: Len Hom, Dublin, CA (US); Gilbert Amador, Dublin, CA (US); Peter J. Kang, San Jose, CA (US); David K. Chan, San Francisco, CA (US)

Correspondence Address: WELLS ST. JOHN P.S., 601 W. FIRST AVENUE, SUITE 1300, SPOKANE, WA, 99201, US

(21) Appl. No.: 10/954,844

(22) Filed: Sep. 29, 2004

(51) Int. Cl. G01K 7/00

(52) U.S. Cl. 374/179

(57) ABSTRACT

The invention includes an insulator comprising a cylindrical portion which has a uniform outer diameter throughout its length, and a tapered portion which has a maximum diameter equivalent to the outer diameter of the cylindrical portion. One or more openings extend through the ceramic insulator substantially along a central axis of the cylindrical portion and the tapered portion. In one aspect, the invention encompasses thermocouple assemblies which comprise ceramic insulators having a tapered portion and a cylindrical portion. One or more openings extend through the ceramic insulators substantially along a central axis of the cylindrical portion and the tapered portion. The invention additionally includes methods of forming thermocouple assemblies and insulators.

### TECHNICAL FIELD

The invention pertains to ceramic insulators and thermocouple assemblies.

### BACKGROUND OF THE INVENTION

Thermocouples are devices utilized for measuring or sensing temperatures by the use of two contacting dissimilar metals. The junction of the differing metals gives rise to a measurable electric potential which varies with the temperature of the junction. In applications such as furnaces, thermocouples can be used to operate temperature indicators and/or heat controls.

In thermocouple assemblies conventionally utilized for heat sensing applications in furnaces, thermocouple wires are typically insulated from each other utilizing insulators such as ceramic beads. Exemplary prior art thermocouple assemblies and bead configuration is discussed with reference to FIGS. 1 and 2. Referring initially to FIG. 1, such shows a portion of a thermocouple assembly 100 which includes a series of individual ceramic insulator beads 10 through which a wire 102 has been inserted. As shown in FIG. 1, ceramic beads 10 can have a first end 12 and a second opposing end 14, and can be strung along wire 102 to insulate the wire from other wires. Ceramic beads 10 can additionally provide support for thermocouple wire. As illustrated in FIG. 1, surfaces of ends 12 and 14 can be flat to allow neighboring beads to contact each other thereby minimizing exposure of wire 102 between the beads. However, the configuration shown in FIG. 1 having interfacing planar surfaces between beads 10 can result in limited flexibility which can cause initial installation, removal or replacement of the thermocouple assembly to be difficult.

An alternative prior art bead configuration is shown in FIG. 2. Rather than having planar front and back surfaces 12 and 14 as discussed above, bead 10 as shown in FIG. 2 has a protruding portion 13 and an opposing indentation or opening 15 such that when strung in series along a wire of a thermocouple assembly protruding region 13 fits insertably into indentation 15. Although the bead configuration of FIG. 2 can sometimes allow increased flexibility relative to the configuration depicted in FIG. 1, the resulting insulated wire (not shown) comprising the insertable beads of FIG. 2 can retain sufficient stiffness and inflexibility as to make installation and/or replacement of the thermocouple assembly difficult, especially in confined spaces. Bending and or stretching of wire during installation can weaken the thermocouple wire and can increase the occurrence of shorting during use thereby decreasing the reliability and useful lifetime of the thermocouple.

It is desirable to develop alternative insulator and thermocouple assembly configurations.

### SUMMARY OF THE INVENTION

In one aspect, the invention encompasses a ceramic insulator comprising a cylindrical portion which has a length and has a uniform outer diameter throughout the length. The ceramic insulator has a first end surface and a tapered portion which has a tapered surface and a maximum diameter equivalent to the outer diameter of the cylindrical portion. The ceramic insulator additionally has a second end surface opposing the first end surface and an opening which extends through the ceramic insulator substantially along a common central axis of the cylindrical portion and the tapered portion.

In one aspect the invention encompasses an insulator having a longitudinal axis centrally located along an entire length of the insulator and having a first portion which extends from a first end of the longitudinal axis along a first length of the longitudinal axis to a first point along the longitudinal axis. The first portion of the insulator has a decreasing circumference along the entire first length from a maximum circumference of the first point to a minimum circumference at the first end of the longitudinal axis. The insulator additionally has a second portion which extends a second length from the first point to a second point along the longitudinal axis. The second portion has a uniform circumference along the entire second length with the uniform circumference being equivalent to the maximum circumference of the first portion.

In one aspect, the invention encompasses thermocouple assemblies which comprise ceramic insulators having a first end surface, a tapered portion and a cylindrical portion with a uniform outer diameter. The tapered portion has a maximum diameter equivalent to the outer diameter of the cylindrical portion. One or more openings extend through the ceramic insulators substantially along a central axis of the cylindrical portion and the tapered portion.

### BRIEF DESCRIPTION OF THE DRAWINGS

Preferred embodiments of the invention are described below with reference to the following accompanying drawings.

FIG. 1 shows a side view of a portion of a ceramic insulator bead type thermocouple in accordance with the prior art.

FIG. 2 is a side view of an alternative insulator bead configuration of the prior art.

FIG. 3 shows a side view of an exemplary insulator configuration of; the present invention.

FIG. 4 shows a cross sectional view of the insulator of FIG. 3, taken along line 44 of FIG. 3.

FIG. 5 is a side view of an alternative insulator configuration in accordance with the present invention.

FIG. 6 A-F shows various alternative shapes in accordance with the present invention, for a portion of the insulator shown in FIG. 5.

FIG. 7 shows a side view of an alternative insulator shape in accordance with the invention.

FIG. 8 A-B shows additional alternative insulator shapes in accordance with the invention.

FIG. 9 shows a side view of a portion of a thermocouple assembly in accordance with the invention.

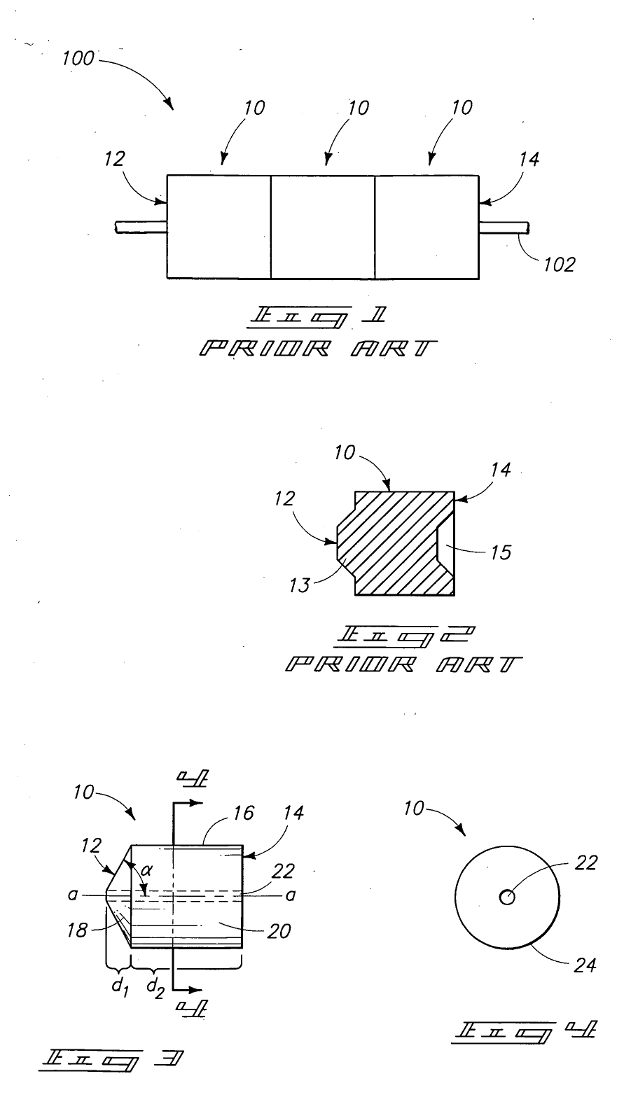

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

The invention encompasses thermocouple insulator configurations which can provide flexibility to thermocouples, and flexible thermocouple assemblies. Utilization of insulators or ‘insulator beads’ in accordance with the invention can allow a thermocouple to articulate at one or more points, or at a series of points along a length of an insulated thermocouple wire. The resulting flexibility can decrease the difficulty in installation or replacement of thermocouple assemblies, can decrease or avoid stretching the thermocouple wire, and can minimize bending, kinking and/or twisting of the wire. Stretching, kinking or twisting of the thermocouple wires can result in shorted junctions and/or an increased tendency to short at the stretched kinked or twisted location. Accordingly, insulator configurations and thermocouple assemblies of the invention which minimize or avoid these drawbacks help maintain the integrity of the assemblies and provide increased thermocouple lifetime.

In general, the insulator configurations of the invention provide a decreased or minimized surface contact between insulator beads in series along a thermocouple wire relative to conventional configurations. The decreased contact area allows movement or pivoting to result thereby providing increased flexibility. It is to be understood that the geometries and configurations discussed below are exemplary and that the invention is not limited the insulators specifically described.

Insulator configurations in accordance with the invention are described generally with reference to FIGS. 3-8. Referring initially to FIG. 3, such shows an insulator or “bead” 10 having a first end 12, a second end 14, and an outer surface 16. Insulator 10 has a longitudinal axis ‘a’ which is substantially centered across the entire length of insulator 10. In particular instances, longitudinal axis ‘a’ can preferably be an axis of symmetry. Insulator 10 can be described as having a first portion 18 and a second portion 20. First portion 18 can encompass a first distance ‘d₁’ which extends from first end 12 along longitudinal axis ‘a’ to a first point. Second portion 20 can extend from an interface with first portion 18 at the positioned of the first point along longitudinal axis ‘a’, to a second point along the longitudinal axis measured by ‘d₂’.

The lengths of d₁ and d₂, and their relative lengths are not limited to any particular values. The length of portion 20 measured by d_{1,} can vary depending upon the desired degree of flexibility in the assembled thermocouple unit. As shown if FIG. 3, the value of d₂ can exceed the value of d_{1,} and in particular section 20 can comprise the majority of the insulator volume. In alternative applications, the value of d₁ can equal or exceed the value of d₂.

Insulator 10 can comprise one or more holes or openings 22 (also referred to as bores). As depicted, a single opening 22 can extend substantially centrally through insulator 10 along central axis ‘a’, from first end 12 to second end 14. It is to be understood that the relative size of opening 22 depicted in the figures is exemplary and that such can vary depending upon, for example, the thickness of wire used for the particular thermocouple application.

The number of bores or holes 22 is not limited to any particular number and can be, for example, any value present in conventional insulators. In particular applications insulator 10 can have ten bores. Additionally, the pattern or positioning of bores through insulator is not limited. Where a single bore is present, the bore can be substantially along the longitudinal axis as shown in FIG. 3, or can alternatively be alternately positioned though the insulator. Where multiple bores are utilized an exemplary configuration of the bores is in circular formation concentric with the outer diameter of the insulator. Alternative placement of multiple bores can include non-circular patterns, a bore pattern comprising multiple circles, and random or un-patterned bore placement.

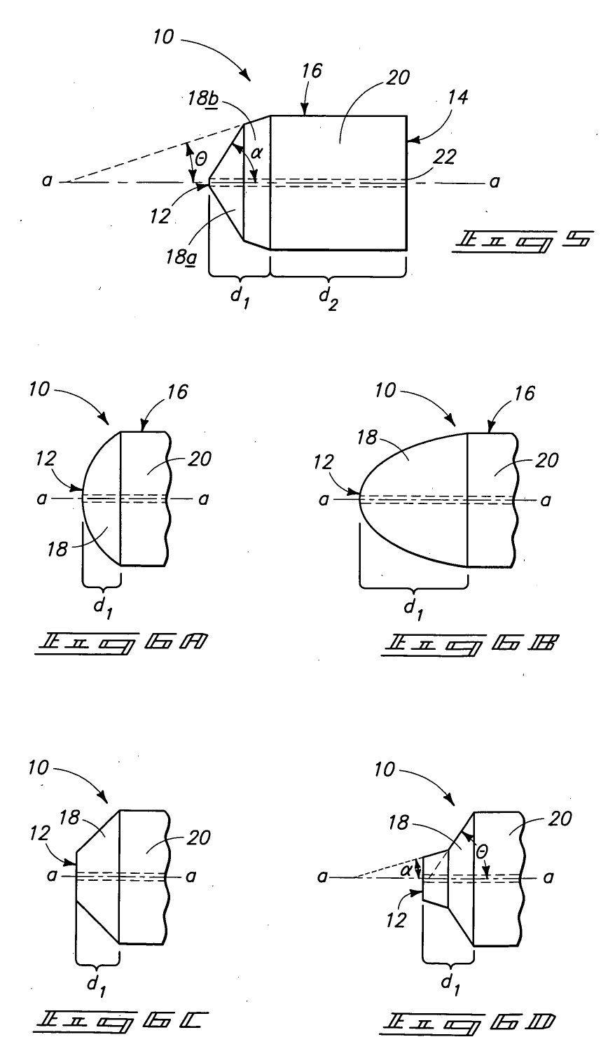

Referring to FIG. 4, such shows a cross-sectional view of insulator 10, the cross-section being taken along line 4-4 of FIG. 3. Accordingly, the cross-section shown in FIG. 4 represents a cross section of second portion 20 of insulator 10. Although alternative shapes of portion 20 are contemplated, in particular applications section 20 can be substantially cylindrical as depicted in FIG. 4. Insulator portion 20 has a circumference 24 which can preferably be uniform along the entire length of this portion. In other words, portion 20 can preferably have a uniform diameter across entire distance d₂.

Although portion 20 is represented in the figures as having a smooth circular circumference, it is to be understood that the invention contemplates alternative surfaces such as, for example, a faceted surface.

Referring again to FIG. 3, first portion 18 of insulator 10 can be described generally as having a continuously decreasing circumference along distance d₁ of longitudinal axis ‘a’. As depicted, section 18 can have a maximum circumference and diameter at the interface between first portion 18 and second portion 20, and a minimum diameter and circumference at first end 12. First portion 18 can in particular instances be described as being a tapered portion of insulator 10. The exemplary shape of portion 18 shown in FIG. 3 can be described a being a conical shape. The term ‘conical’ as used in the present description refers to a substantially intact cone shape, and encompasses shapes where the apex of the cone is displaced by forming opening 22.

An angle of taper ‘α’ is indicated in FIG. 3 and can be defined as being the angle formed between longitudinal axis ‘a’ and the portion of outer surface 16 comprised by first portion 18, as shown. The value of α is not limited to a particular value and can range from greater than 0° to less than 90°. In some applications a can preferably have a value of from about 75° to about 87°, and in particular instances can be about 85 degrees.

Although represented in the figures as being uniform around the entirety of the insulator, it is to be understood that the value of a can differ at one or more positions around the longitudinal axis. The variance of a can be symmetrical or non symmetrical around the central longitudinal axis.

Referring next to FIG. 5, such shows an alternative shape configuration of insulator 10. The first portion of the insulator can comprise two sub-portions 18a and 18b having first taper angle α and a second taper angle θ, where second taper angle θ is defined as the angle formed between the longitudinal axis of insulator 10 and the surface portion of subsection 18b. θ is not limited to any particular value and can be from greater than 0° to less than 90°. As illustrated in FIG. 5, θ can be a smaller angle relative to α. Alternatively, the value of 0 can exceed the value of α (not shown). Sub-portions 18a and 18b can alternatively be described as being a conical sub-portion 18a and a frusto-conical sub-portion 18b. The relative volume of portions 18a and 18b is not limited to a particular value. The invention contemplates a position of the interface 18a and 18b (defined by the plane normal to longitudinal axis ‘a’ which passes through the intersection of the outer surface of subsection 18a and the outer surface of 18b) to occur at any point within length d₁.

The shape of first portion 18 is not limited to the conical or mixed-conical shapes described above with reference to FIGS. 3-5. FIG. 6 views A-F, illustrates a few exemplary shape configurations of section 18. However, such exemplary aspects are not intended to limit the configuration of portion 18 to any particular set of shapes.

FIG. 6A shows an exemplary shape of first portion 18 which can be referred to as a truncated-spherical shape. The portion of a sphere comprised by portion 18 is not limited to a particular spherical section and can depend upon the diameter of section 20 and length d₁ of section 18. In particular instances, section 18 can be hemispherical (not shown). Referring to FIG. 6B, first portion 18 can alternatively be paraboloid the volume of which can vary as determined by the diameter of section 20, the value of distance d₁ and the parabolic curve.

Although it can be preferable in some instances to minimize a contact surface area of end 12, such as in the configurations discussed above, the invention additionally contemplates having a somewhat larger area of contact between neighboring beads relative to the small, nearly point-area contacts described above.

Referring to FIG. 6C, such illustrates an end surface 12 which is larger than the point or near-point contact area of the previously discussed shapes. The shape of portion 18 shown in FIG. 6C can be described as a frusto-conical shape having a minimum diameter at end position 12, and a maximum diameter at a point along the insulator's longitudinal axis at distance d₁ from end surface 12. Although the degree of truncation of a conical shape to produce the frusto-conical portion 18 is not limited to a particular amount, it can be preferable that the area of surface 12 be minimal to allow greater flexibility in the assembled thermocouple.

The alternative shape configuration depicted in FIG. 6D can be described as comprising a combination of frusto-conical shapes. The first frusto-conical shape which comprises end surface 12, has a first taper angle α. The second frusto-conical portion has a maximum diameter equivalent to the diameter of second portion 20, and has a taper angle θ. As discussed in the embodiments above, the values of α and θ, as well as the volumes of the first frusto-conical section and second frusto-conical section of portion 18 of insulator 10 can vary.

The invention additionally contemplates shape configurations of first portion 18 which comprises combinations of the various shapes described above. For example, with reference to FIG. 6E, section 18 can comprise a truncated sphere portion at first end 12 and a frusto-conical portion at the interface of section 20. FIG. 6F shows an alternative combination having a frusto-conical section located at end 12 and a truncated-spherical portion at the interface between parts 18 and 20 of insulator 10. It is to be understood that the invention further contemplates alternative shapes and combinations of shapes for first portion 18 such as for example, truncated ellipsoid shapes and combinations of shapes not specifically illustrated. Additionally, portion 18 can be shaped such that surface 16 comprises planar and/or stepped regions, as long as the general shape has decreasing cross-sectional area progressing along the longitudinal axis toward end 12.

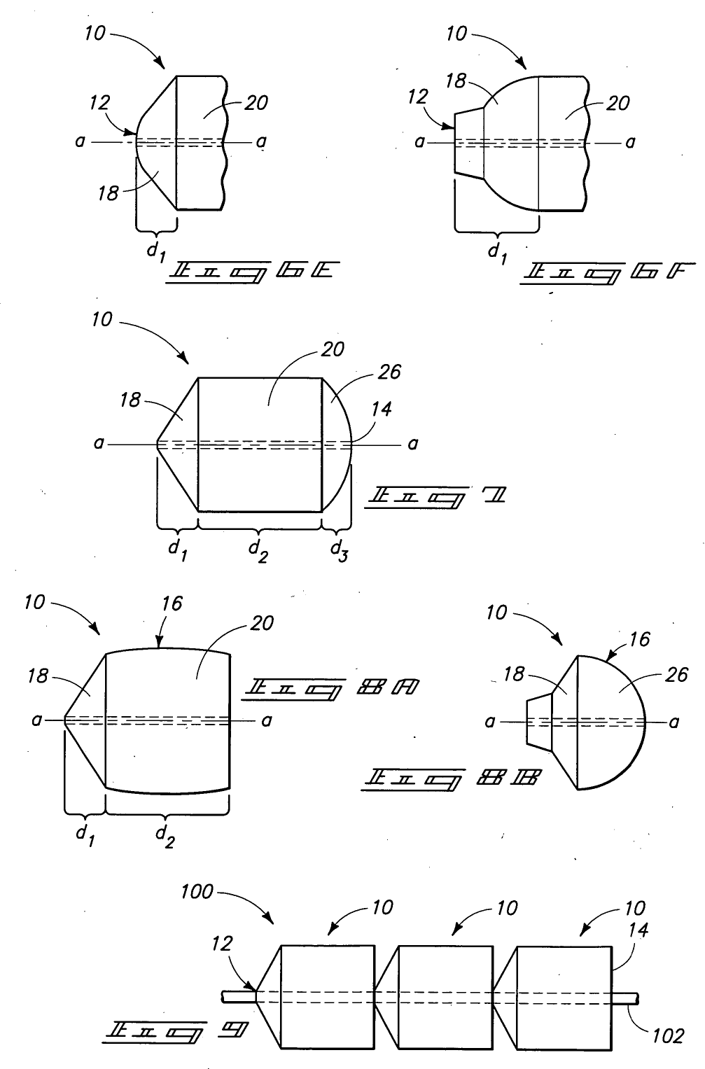

Referring to FIG. 7, such shows an additional aspect of the invention. As shown, insulator 10 can, in addition to first portion 18 and second portion 20, comprise a third portion 26 which extends from an interface between portions 20 and 26 to an end point at end surface 14. In other words, section 26 can extend from an end surface 14 along the longitudinal axis a distance d₃. The shape of third portion 26 can be truncated spherical as depicted in FIG. 7, or can alternatively be any of the shapes described above with respect to first portion 18. It can be advantageous to provide a contoured third portion to decrease and/or minimize the contact surface between neighboring insulators in a series of insulators along a thermocouple wire. Such configuration can further enhance thermocouple assembly flexibility, can minimize bending and twisting and thereby avoid or minimize the occurrence of shorting.

As shown in FIG. 7, the shapes and sizes (volume and/or relative values of d₁ and d₃) can differ. Alternatively, sections 18 and 26 can have identical shapes and sizes such that the first and third portions of insulator 10 are three-dimensional mirror images relative to one another (not shown).

Referring to FIG. 8A, such illustrates an alternative shape configuration for second portion 20 of insulator 10. As shown, the portion of outer surface 16 comprised by section 20 can be rounded such that the diameter and circumference of section 20 varies along its length. Although FIG. 8A depicts a symmetrical arc shape for surface 16, the invention contemplates alternative shapes including non-symmetrical curves, stepped shapes, concave shapes and various combinations thereof.

The invention further contemplates insulators having an absence of second portion 20 such as that depicted in FIG. 8B. As shown in panel B, a first shaped portion 18 can directly interface an opposing shaped portion 26. As shown, the two shaped portions can be different in size and/or shape. Alternatively, portions 18 and 26 can be three-dimensional mirror images of each other (not shown). Portions 18 and 26 can comprise any of the shapes described above with respect to these portions.

Although the above described configurations indicate a central or substantially central contact point or pivot point at first surface 12, it is to be understood that the invention contemplates alternative pivot points which are not concentric with the outer diameter of the insulator. Additionally, the concepts described above can be adapted to bead shapes having other than the uniform circular or substantially circular perimeters represented in the figures. Exemplary alternative outer perimeter shapes can include rectangular, oblong oval, polygonal, and combinations thereof. Further, the general perimeter shape can vary along the length of the insulator.

A thermocouple assembly in accordance with the invention is described generally with reference to FIG. 9. A portion of a thermocouple assembly 100 can comprise a series of insulator beads 10 in a first end 12 to second end 14 (or front-to-back) configuration, threaded along a thermocouple wire 102. Insulators 10 can comprise any of the insulator configurations discussed above. As shown in FIG. 9, each of insulators 10 can have an identical configuration. Alternatively, a series of beads along a wire can comprise a combination of bead configurations which can include any of the configurations discussed above in any sequence or combination. Further, the insulator configurations of the inventions can be utilized in combination with beads having configurations utilized in conventional thermocouple assemblies. For example, conventional insulators can be used along a portion of a thermocouple wire, and insulators in accordance with the invention can be provided at specific locations to provide an increased degree in flexibility at a desired position or location in the thermocouple assembly.

In addition to the front-to-back bead alignment shown in FIG. 9, the invention additionally contemplates alternative bead alignment where some or all of the beads are threaded such that neighboring beads are positioned front-to-front (first end 12 of one bead interfacing first end 12 of a second neighboring bead, not shown).

Although the inter-bead alignment shown in FIG. 9 is substantially concentric, the invention contemplate alignments wherein a first surface of one or more neighboring beads in a series of beads interfaces a first or second side of an adjacent bead in a non-concentric manner.

The insulators encompassed by the invention can be formed using conventional or yet to be developed techniques for insulator fabrication. Such techniques can comprise for example machining to obtain the desired shape.

The composition of insulators of the invention is not limited to any particular insulative material. Exemplary materials can be any of the insulative materials used conventionally in thermocouple applications, or insulative materials yet to be developed. Preferable insulative materials can be ceramic materials, including but not limited to alumina, mullite, quartz, sapphire and steatite.

Thermocouple assemblies having insulators formed in accordance with the invention can have improved flexibility allowing ease of insulation removal and replacement of the thermocouple assembly or portions thereof. Such can be especially useful for application such as processing furnaces which have limited access space for removal and installation of the thermocouple assemblies.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A ceramic insulator comprising:
a cylindrical portion having a length and having a uniform outer diameter throughout the length;
a first end surface;
a tapered portion having a tapered surface and having a maximum diameter equivalent to the outer diameter of the cylindrical portion;
a second end surface opposing the first end surface; and
an opening extending through the ceramic insulator substantially along a common central axis of the cylindrical portion and the tapered portion.

2. The insulator of claim 1 wherein the tapered surface is faceted.

3. The insulator of claim 1 wherein the tapered portion has a conical shape.

4. The insulator of claim 1 wherein the tapered portion has a frusto-conical shape.

5. The insulator of claim 1 wherein the first end surface has a diameter equivalent to the outer diameter of the cylindrical portion.

6. The insulator of claim 1 wherein the tapered portion is a first tapered portion and further comprising a second tapered portion separated from the first tapered portion by the cylindrical portion, the first tapered portion having a direction of taper and the second taper portion having an opposite direction of taper.

7. The insulator of claim 6 wherein the first and second tapered portions have equivalent taper angles relative to each other.

8. The insulator of claim 6 wherein the first and second taper regions have non-equivalent taper angles relative to each other.

9. The insulator of claim 1 wherein the cylindrical portion extends to the first end surface.

10. The insulator of claim 1 wherein the insulator comprises an insulator material selected form the group consisting of alumina, mullite, quartz, sapphire, and steatite.

11. A thermocouple assembly comprising at least one of the insulator of claim 1.

12. An insulator comprising:
a first end having a first end surface having a first diameter;
a first frusto-conical portion extending from the first end surface a first distance to a first point along a central axis of the insulator; and
a second frusto-conical portion extending from the first point a second distance along the central axis of the insulator to a second point.

13. The insulator of claim 12 wherein the first and second frusto-conical portions share a common base plane and taper in opposite directions.

14. The insulator of claim 12 wherein the first and second truncated-conical portions taper in the same direction.

15. The insulator of claim 14 wherein the first frusto-conical portion has a first angle of taper and the second frusto-conical portion has a second angle of taper, the second angle of taper being different than the first.

16. A thermocouple assembly comprising at least one of the insulator of claim 12.

17. An insulator comprising:
a longitudinal axis centrally located along an entire length of the insulator;
a first portion extending from a first end of the longitudinal axis along a first length of the longitudinal axis to a first point along the longitudinal axis, the first portion having a decreasing circumference along the entire first length from a maximum circumference at the first point to a minimum circumference at the first end of the longitudinal axis; and
a second portion extending a second length from the first point to a second point along the longitudinal axis, the second portion having a uniform circumference along the entire second length, the uniform circumference being equivalent to the maximum circumference of the first portion.

18. The insulator of claim 17 wherein the first portion comprises a conical shape.

19. The insulator of claim 17 wherein the first portion comprises a truncated spherical shape.

20. The insulator of claim 19 wherein the first portion is truncated-spherical.

21. The insulator of claim 17 wherein the first portion comprises a first portion of an external surface and the second portion comprises a second portion of an external surface, at least one of the first and second portions of the external surface being faceted.

22. The insulator of claim 17 wherein the second point is disposed at a second end of the longitudinal axis.

23. The insulator of claim 17 further comprising a third portion extending a third length from the second point on the longitudinal axis to a second end of the longitudinal axis, the third portion having a decreasing circumference along the entire third length from a maximum circumference at the second point to a minimum circumference at the second end of the longitudinal axis.

24. The insulator of claim 23 wherein the third portion comprises a shape that three-dimensional mirror images the shape of the first portion.

25. The insulator of claim 23 wherein the third portion comprises a shape that does not mirror the shape of the first portion.

26. A thermocouple assembly comprising at least one of the insulator of claim 17.

27. An insulator comprising:
a longitudinal axis centrally located along an entire length of the insulator;
a first portion extending from a first end of the longitudinal axis along a first length of the longitudinal axis to a first point along the longitudinal axis, the first portion having a decreasing circumference along the entire first length from a maximum circumference at the first point to a minimum circumference at the first end of the longitudinal axis; and
a second portion extending a second length from the first point to a second end of the longitudinal axis, the second portion having a decreasing circumference along the entire third length from a maximum circumference at the first point to a minimum circumference at the second end of the longitudinal axis, at least one of the first and second portions being non-hemispherical.

28. The insulator of claim 27 wherein the first and second distances are equivalent.

29. The insulator of claim 27 wherein the first and second distances are non-equivalent.

30. The insulator of claim 27 wherein the first and second portions are three-dimensional mirror images of each other.

31. The insulator of claim 27 wherein the first portion comprises a shape selected from conical, frusto-conical, truncated spherical, paraboloid, and truncated ellipsoid.

32. A thermocouple assembly comprising at least one of the insulator of claim 27.
